(19) United States
(12) Patent Application Publication
(10) Pub. No.: US 2013/0222776 A1
(43) Pub. Date: Aug. 29, 2013

(54) IMAGE PROJECTOR, METHOD OF IMAGE PROJECTION, AND COMPUTER-READABLE STORAGE MEDIUM STORING PROGRAM FOR CAUSING COMPUTER TO EXECUTE IMAGE PROJECTION

(71) Applicant: Masaaki ISHIKAWA, Kanagawa (JP)

(72) Inventor: Masaaki ISHIKAWA, Kanagawa (JP)

(21) Appl. No.: 13/772,839

(22) Filed: Feb. 21, 2013

(30) Foreign Application Priority Data
Feb. 23, 2012 (JP) 2012-037332

(51) Int. Cl. G03B 21/14

(52) U.S. Cl. CPC G03B 21/147
USPC 353/121; 353/69

(57) ABSTRACT

An image projector includes a pattern image generator generating image data of a pattern image which specifies a position of a grid point by a flat portion as an intermediate tone level of a background image, a high tone portion higher than the intermediate tone level and a low tone portion lower than the intermediate tone level; a projection device projecting the pattern image on a screen; an image for correction input device inputting an imaged image for correction; a geometric distortion detector detecting geometric distortion information of the grid point which divides the imaged image for correction into blocks based on an imaged image for correction where the pattern image projected on the screen has been imaged and inputted by the image for correction input device; and a geometric distortion corrector correcting geometric distortion of a projected image projected on the screen based on the geometric distortion information.

### CROSS-REFERENCE TO RELATED APPLICATIONS

The present application is based on and claims priority from Japanese Patent Application Number 2012-037332, filed Feb. 23, 2012, the disclosure of which is hereby incorporated by reference herein in its entirety.

### BACKGROUND

The present invention relates to an image projector that is suitable for correcting geometric distortion occurring in a short-throw image projector, a method of image projection, and a computer-readable storage medium storing a program for causing a computer to execute image projection.

Ultra short-focus projectors (short-throw image projectors), which have been developed in recent years, project an image from a very close distance to a screen, and therefore, even if a presenter crosses in front of viewers, there is an advantage in not interfering with projection, or the like. However, on the other hand, the image is projected by elevation projection from a very close distance from the screen, and therefore, on a general hanging-type sheet screen, there is a problem in that tiny shape distortion on a surface of the screen appears as large distortion when viewing a projected image at the front of the screen.

The term elevation projection refers to, in a case of a projector, an optical axis of a projection lens and a center of a DMD (Digital Mirror Device) or a liquid crystal panel being displaced, and an image being formed such that the center of the screen comes above the optical axis of the projection lens.

There are many cases where conventional projectors have a correction function of trapezoid distortion in which an entire picture plane of a projected image projected on a screen deforms in a trapezoidal shape in a case where the image is projected from a direction displaced from the front of the screen.

However, geometric distortion caused by distortion on a screen in an ultra short-focus projector as described above is non-linear distortion that is not corrected by correcting trapezoid distortion of the entire picture plane. Additionally, undulation of a surface shape of the screen is different in positions on a surface of the screen, and appears as irregular distortion on the surface of the screen.

As a method of correcting geometric distortion of a projected image caused by such a shape of the screen, “An Experimental Study on Geometric Correction for Projected Images, the 235th meeting of the Society of Instrument and Control Engineers Tohoku Chapter, May 18, 2007, information 235-5” (hereinafter, referred to as Non-Patent Document) has proposed a method of correcting an image on a frame memory in advance such that an original image to be projected is divided into small square blocks, a distortion parameter (correspondence of four apexes of the block between the original image and a projected image) is measured per block, and based on the above, deformation opposite to the distortion is performed per block unit.

In Non-Patent Document, in the measurement of the geometric distortion per block, a pattern coding method is used. In the pattern coding method, a plurality of gray code patterns (vertical or horizontal black-and-white striped patterns corresponding to gray codes) is projected, each of those is imaged by a camera from a direction of a viewer, and from a plurality of images obtained, each corresponding point of each block of each image by the projector and by the camera, that is, the geometric distortion per block, is corrected.

However, in a case of an ultra short-focus projector, an arranged position of the ultra short-focus projector is greatly different from a position of a viewer viewing the projected image on the screen, and in principle, it is difficult for an internal camera of the ultra short-focus projector to image the distortion of the projected image shown to the viewer at the front of the screen, because from a position of the internal camera of the ultra short-focus projector, the projected image is viewed from a direction where there is little difference from an optical axis of the projector.

FIG. 17 is an explanatory diagram illustrating a principle in which it is not possible for the ultra short-focus projector to image distortion of a projected image shown to a viewer viewing at the front of a screen from an arranged position of the projector.

A position where the screen should be arranged is taken as a screen position 100, and a position where the screen is displaced by deflection is taken as a screen position 101. In this case, a difference between the screen position 100 and the screen position 101 is small; however, a displacement width d in the vertical direction of an image projected from a closest distance to the screen amplifies larger than the above. The smaller an angle between projector light and the screen becomes, the larger this amplification rate becomes.

Such distortion caused by the screen is easily watched by imaging by a camera 200 at the front of the screen, or by watching by a viewer at the front of the screen; however, it is almost impossible to image or watch a distortion image caused by a small angular difference, because the distortion is imaged or watched from a view point close to an optical axis of the projector when shooting by an internal camera 121 of an ultra short-focus projector 110, or watching by a viewer from a position of the above.

Therefore, in a case of performing distortion correction of the ultra short-focus projector 110 by using the internal camera 121, for example, it is necessary to provide a stereo camera that measures distance to the screen in addition to the internal camera 121, measure the distance to the screen by using the stereo camera, obtain a three-dimensional shape of the screen, and convert an image imaged by the internal camera 121 to an image viewed from a direction of the viewer (the front of the screen), after.

However, in a case of such a constitution, as the internal camera 121 of the ultra short-focus projector 110, an ultra wide-angle camera with a highly-accurate distance sensor, or an ultra wide-angle stereo camera is needed, and therefore, there is a problem in that cost increases.

Therefore, as a method of performing geometric distortion correction of the ultra short-focus projector without an increase in cost, a method of performing correction in which a plurality of pattern images projected on the screen is shot from a direction of a viewer (the front of the screen) by using an external camera, and the plurality of the pattern images shot is used is considered. However, in a case where shooting of a plurality of pattern images by an external camera is needed, it is necessary to fix the external camera, and set a tripod among audience seats and so on, and therefore, it is not realistic. Accordingly, in a case of performing the geometric distortion correction of the ultra short-focus projector by using the external camera, it is necessary to configure to require only one shooting of a pattern image.

Generally, in order to measure distortion with one pattern image, it is considered to detect a corresponding point of a grid point by using a checker pattern, a thin-line grid pattern, or the like.

Additionally, in the pattern coding method, in order to stably perform binarization in consideration of an influence of environmental light such as fluorescent light, or the like, a binarization method (complementary pattern projection method) in which inverted negative and positive patterns are used, instead of binarization by a fixed threshold value, waveforms of imaged images of negative and positive patterns are overlapped, and a result of binarization switches in a position where that value is intersected is often performed. However, the above method is not available in a case of one pattern image, it is easy to be affected by environmental light, and there is a problem in that it is difficult to obtain a corresponding point

In addition, as for an ultra short-focus projector that projects an image in an elevation manner from a closest distance even under a dark room condition without environmental light, due to a difference of a position of a projected image on the surface of the screen, a distance from the ultra short-focus projector is greatly different, and therefore, a portion close to the projector is brighter, and there is a problem in that it is difficult to secure uniformity of brightness of the projected image on the surface.

Note that Japanese Patent Application Publication No. 2010-288062 has proposed a method in which a position of a pattern of “+” or “a grid” is accurately and easily detected even in a case of being out-of focus by preparing one pattern image for trapezoid correction, and forming a straight line constituting a pattern to be in a gradation manner; however, the influence of environmental light is not considered.

### SUMMARY

An object of the present invention is to provide an image projector that easily corrects geometric distortion caused by distortion of a screen without an increase in cost, a method of image projection, and a computer-readable storage medium storing a program for causing a computer to execute image projection.

In order to achieve the above object, an embodiment of the present invention provides an image projector, comprising: a pattern image generation device that generates image data of a pattern image which specifies a position of a grid point by a flat portion as an intermediate tone level of a background image, a high tone portion which is a higher tone level than the intermediate tone level and a low tone portion which is a lower tone level than the intermediate tone level; a projection device that projects the pattern image on a screen; an image for correction input device that inputs an imaged image for correction; a geometric distortion detection device that detects geometric distortion information of the grid point which divides the imaged image for correction into blocks based on an imaged image for correction in which the pattern image projected on the screen has been imaged and inputted by the image for correction input device; and a geometric distortion correction device that corrects geometric distortion of a projected image projected on the screen by the projection device based on the geometric distortion information.

In order to achieve the above object, an embodiment of the present invention provides an image projector, comprising: a pattern image generation device that generates image data of a pattern image which specifies a position of a grid point by a flat portion as an intermediate tone level of a background image, a high tone portion that is a higher tone level than the intermediate tone level, and a low tone portion that is a lower tone level than the intermediate tone level and surrounded by the high tone portion; a projection device that projects the pattern image on a screen; an image for correction input device that inputs an imaged image for correction; a geometric distortion detection device that detects geometric distortion information of the grid point which divides the imaged image for correction into blocks based on an imaged image for correction in which the pattern image projected on the screen has been imaged and inputted by the image for correction input device; and a geometric distortion correction device that corrects geometric distortion of a projected image projected on the screen by the projection device based on the geometric distortion information.

In order to achieve the above object, an embodiment of the present invention provides a method of image projection, comprising the steps of: generating image data of a pattern image that specifies a position of a grid point by a flat portion as an intermediate tone level of a background image, a high tone portion that is a higher tone level than the intermediate tone level and a low tone portion that is a lower tone level than the intermediate tone level; projecting the pattern image on a screen; inputting an imaged image for correction; detecting geometric distortion information of the grid point which divides the imaged image for correction into blocks, based on an imaged image for correction in which the pattern image projected on the screen has been imaged and inputted in the step of inputting the imaged image for correction; and correcting geometric distortion of a projected image projected on the screen based on the geometric distortion information.

In order to achieve the above object, an embodiment of the present invention provides a non-transitory computer-readable storage medium storing a program for causing a computer to execute image projection, comprising the steps of: generating image data of a pattern image which specifies a position of a grid point by a flat portion as an intermediate tone level of a background image, a high tone portion that is a higher tone level than the intermediate tone level and a low tone portion that is a lower tone level than the intermediate tone level; projecting the pattern image on a screen; inputting an imaged image for correction; detecting geometric distortion information of the grid point which divides the imaged image for correction into blocks based on an imaged image for correction in which the pattern image projected on the screen has been imaged and inputted in the step of inputting the imaged image for correction; and correcting geometric distortion of a projected image projected on the screen based on the geometric distortion information.

### BRIEF DESCRIPTION OF THE DRAWINGS

FIG. 1 is a block diagram illustrating a constitution of a projector according to an embodiment of the present invention.

FIG. 2 is a flow diagram illustrating a geometric distortion correction operation executed by the projector according to the present embodiment.

FIG. 3 is a flow diagram illustrating a first detection operation performed by a geometric distortion detection device of the projector according to the present embodiment.

FIG. 4A is a pattern image in the first detection operation, and FIG. 4B is a cross-sectional diagram in a line A-A illustrating a brightness value of the pattern image illustrated in FIG. 4A.

FIG. 5 is a diagram illustrating a position of a pixel in a flat portion as an intermediate position per unit of 2×2 grid points by a white circle when detecting the pattern image illustrated in FIG. 4A.

FIG. 6 is a diagram illustrating an example where from a pixel value in the flat portion as the intermediate position per detected unit of 2×2 grid points, a component (direct-current components) of environmental light in positions of entire pixels other than in the above is calculated by linear interpolation.

FIG. 7A is a diagram illustrating an example of a patch image in which brightness represented in 256 tones is divided equally into 16 scales. FIG. 7B is a diagram illustrating an example of an input-output characteristic measured by imaging the patch image illustrated in FIG. 7A.

FIG. 8 is a diagram illustrating a thin-line grid pattern as an example of a pattern image.

FIG. 9 is a diagram illustrating an image of contents (aspect ratio 4:3).

FIG. 10 is a diagram illustrating an example where a projected image of the contents magnified while maintaining the aspect ratio 4:3 in a maximum size internally-contacted with a region surrounded by an outer circumference of the obtained grid point is mapped.

(a), (b), and (c) of FIG. 11 are diagrams illustrating an example where a coordinate in each position of the grid position is converted to a coordinate on a same size original image corresponding to a position on the mapped projected image of the contents.

FIG. 12 is a flow diagram illustrating a geometric distortion correction operation executed by the projector according to the present embodiment.

FIG. 13 is a second detection operation of the geometric distortion correction device of the projector according to the present embodiment.

FIG. 14A is a pattern image in the second detection operation. FIG. 14B is a cross-sectional diagram in a line B-B illustrating a brightness value of the pattern image illustrated in FIG. 14A.

FIG. 15 is a diagram illustrating a pixel position in a flat portion as an intermediate position per unit of 2×2 grid points by a white circle when detecting the pattern image illustrated in FIG. 14A.

FIG. 16 is a diagram illustrating an example where from a pixel value in the flat portion as the intermediate position per detected unit of 2×2 grid points, a component (direct-current components) of environmental light in positions of entire pixels other than in the above is calculated by linear interpolation.

FIG. 17 is a diagram explaining a principle in which distortion of a projected image shown to a viewer viewing at the front of a screen is not able to be imaged from an arranged position of the projector, in an ultra short-focus projector.

### DETAILED DESCRIPTION OF THE PREFERRED EMBODIMENTS

Hereinafter, an embodiment of the present invention will be explained.

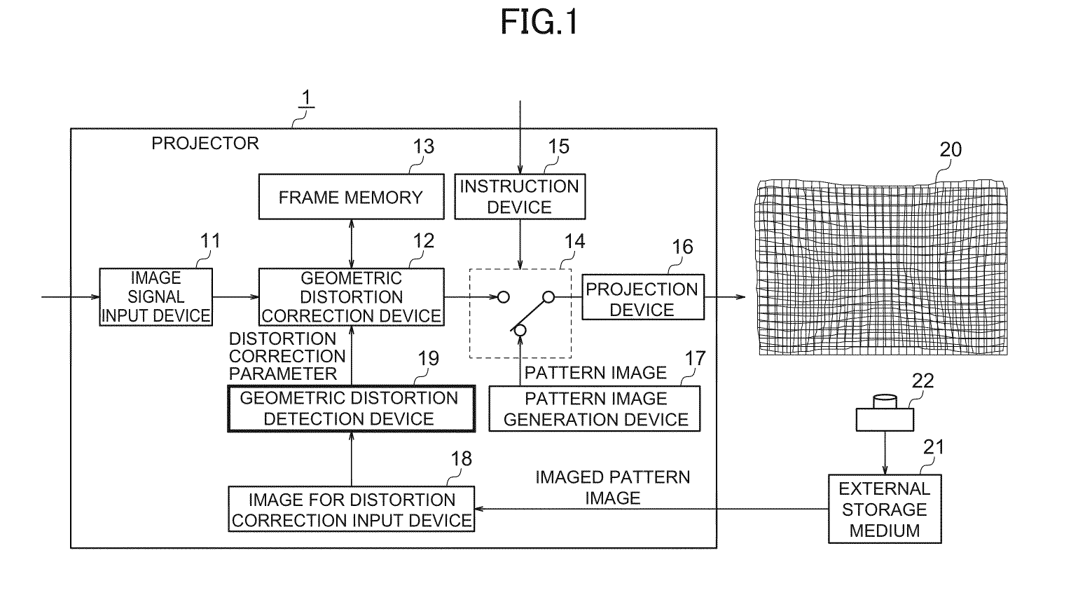

FIG. 1 is a block diagram illustrating a constitution of an image projector according to an embodiment of the present invention.

An image projector (hereinafter, simply referred to as a projector) 1 illustrated in FIG. 1 is a short-throw image projector, and includes an image signal input device 11, a geometric distortion correction device 12, a frame memory 13, a selector switch 14, an instruction device 15, a projection device 16, a pattern image generation device 17, an image for geometric distortion correction input device (image for correction input device) 18, a geometric distortion detection device 19, and the like.

The image signal input device 11 is an input device for inputting an image signal of an image to be projected on a screen 20 from outside.

In a case where distortion correction is performed on an image signal inputted from the image signal input part 11, the geometric distortion correction device 12 corrects each frame of the image signal based on a distortion correction parameter on the frame memory 13 and outputs it. Additionally, in a case where the distortion correction is not performed, the geometric distortion correction device 12 outputs the image signal without performing the distortion correction.

The selector switch 14 is a switch for selecting an input signal to the projection device 16 by instruction of the instruction device 15. The geometric distortion correction device 12 is connected to one of the selector switch 14, and the pattern image generation device 17 is connected to the other of the selector switch 14.

The instruction device 15 performs switching control of the selector switch 14 based on operation information from an operation device such as an operation panel (not-illustrated), a remote controller, or the like.

The projection device 16 projects an image corresponding to an image signal inputted via the selector switch 14 on the screen 20.

The pattern image generation device 17 generates a pattern image for geometric distortion detection. Note that details of the pattern image will be described later.

The image for distortion correction input device 18 stores pattern image data as an image for distortion correction from an external storage medium 21 when the external storage medium is connected.

The pattern image data stored in the external storage medium 21 is obtained by imaging the screen 20 from the front by a digital camera (imaging device) 22 of a user in a state where the pattern image for distortion correction is projected on the screen 20.

The geometric distortion detection device 19 analyses the pattern image data inputted from the image for distortion correction input device 18, and outputs a distortion correction parameter to the geometric distortion correction device 12.

### FIRST EXAMPLE

Next, geometric distortion correction executed by the projector 1 according to the present embodiment will be explained.

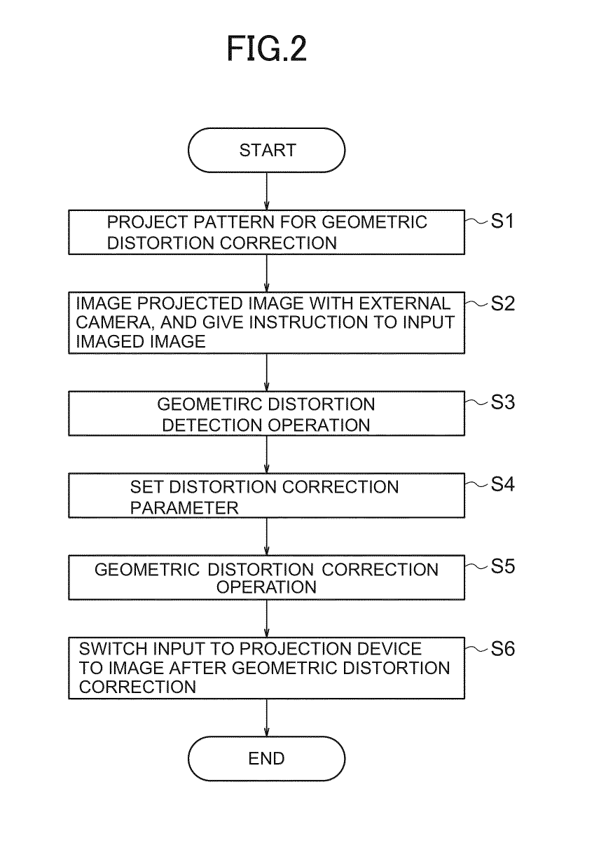

FIG. 2 is a flow diagram illustrating a geometric distortion correction operation executed by the projector 1 according to the present embodiment.

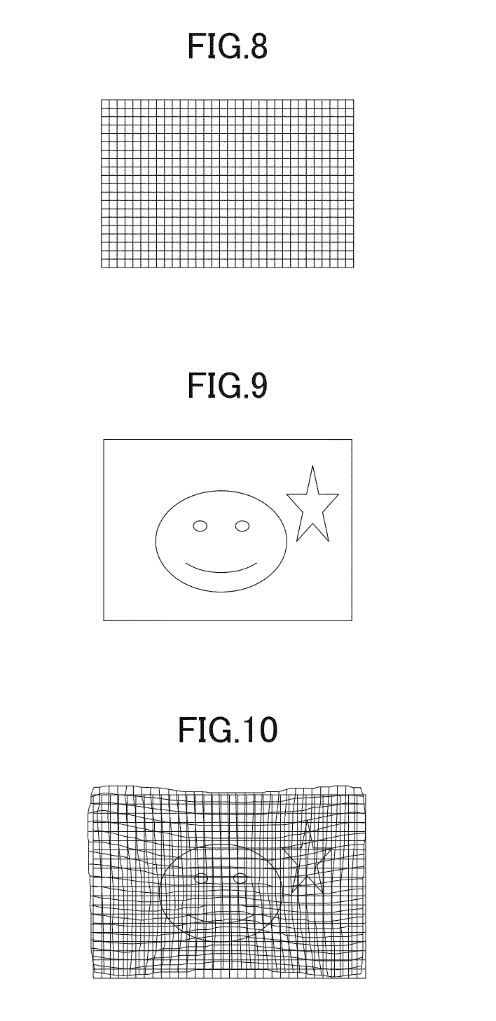

In a case where geometric distortion correction is performed in the projector 1 in the present embodiment, for example, a predetermined operation is performed with respect to the operation panel (not-illustrated) by the user. By this operation, the instruction device 15 switches the selector switch 14, and in place of an image signal from the image signal input device 11, inputs pattern image data for geometric distortion detection generated in the pattern image generation device 17 to the projection device 16. Thus, a pattern for geometric distortion correction is projected on the screen 20 from the projection device 16 (Step S1). On the screen 20 in FIG. 1, as a pattern image, a projected image in a case of projecting a thin-line grid pattern as illustrated in FIG. 8 is illustrated.

Next, the user is instructed to image a projected image projected on the screen 20 by the digital camera 22, and store it on the external storage medium 21, and input the imaged projected image stored in the external storage medium 21 to the image for distortion correction input device 18 of the projector 1 (Step S2). In a case where a display panel (not-illustrated) is provided in the projector 1, for example, it is possible to make such an instruction by using the display panel. And in a case where an audio output device is provided, it is possible to make the instruction by sound. The pattern image imaged by the digital camera 22 at this time has geometric distortion caused by a shape of the screen 20.

Next, in the projector 1, a geometric distortion detection operation that analyses the imaged pattern image inputted in the image for distortion correction input device 18 is performed (Step S3), and a distortion correction parameter obtained by the analysis is set in the geometric distortion correction device 12 (S4).

The geometric distortion correction device 12 performs a geometric distortion correction operation that corrects an image signal per frame on the frame memory 13, based on the distortion correction parameter (Step S5).

When the geometric distortion correction device 12 starts performing the geometric distortion correction operation, the instruction device 15 switches input to the projection device 16 from the pattern image of the pattern image generation device 17 to an image signal after correction outputted from the geometric distortion correction device 12 (Step S6).

Thus, an image in which the geometric distortion caused by the screen 20 is corrected, that is, an image in which the geometric distortion detected by the geometric distortion detection device 19 is adversely transformed is projected on the screen 20, and it is possible to display the image as a projected image in which distortion is corrected.

Next, a detection operation executed by the geometric distortion detection device 19 of the projector 1 according to the present embodiment will be explained.

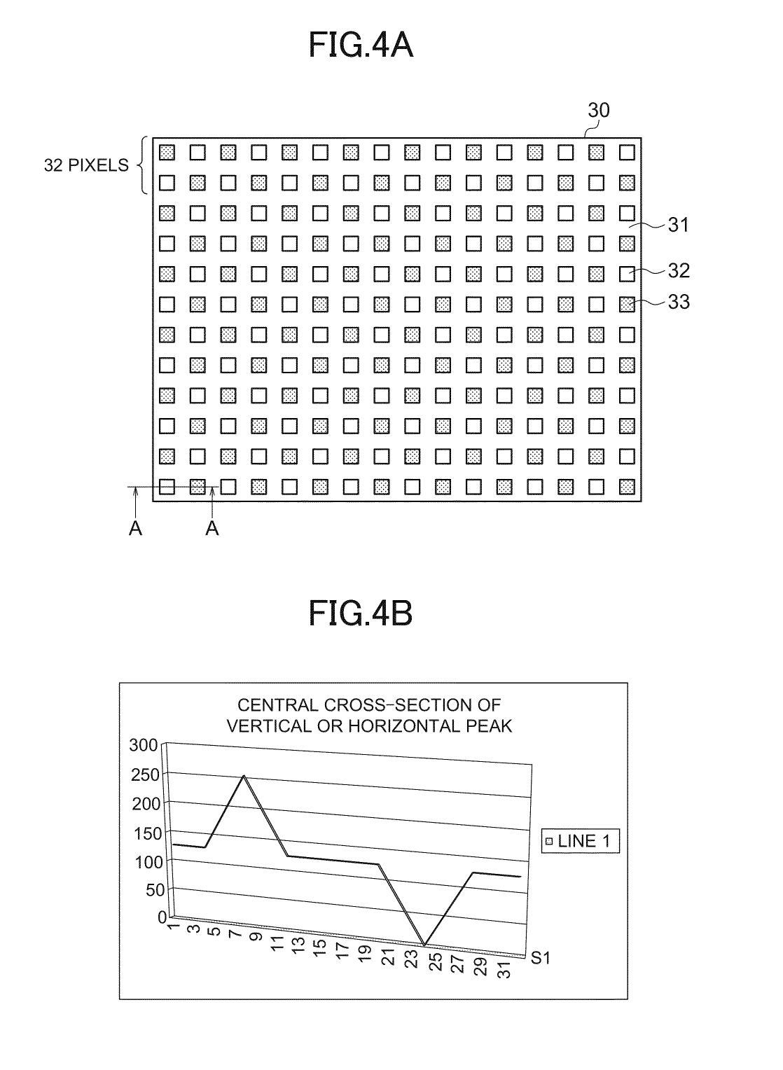

Firstly, a pattern image used in the first detection operation executed by the geometric distortion detection device 19 will be explained. FIG. 4A is a pattern image used in the first detection operation, and FIG. 4B is a cross-sectional diagram in an A-A line illustrating a brightness value of the pattern image illustrated in FIG. 4A. In FIGS. 4A and 4B, the pattern image is illustrated by an image of a 256×192 pixel size.

In a pattern image 30 illustrated in FIG. 4A, in an intermediate tone level (a brightness value of 128 in this example) 31 of a background image, a peak portion 32 and a bottom portion 33 which become a position of a grid point per unit of 16 pixels are alternately arranged. The peak portion 32 is a high tone portion that is higher in the brightness value (for example, a brightness value of 255) than that of the intermediate tone level 31. And the bottom portion 33 is a low tone portion that is lower in the brightness value (for example, a brightness value is 0) than that of the intermediate tone level 31.

Distortion of a screen is non-linear; however, since it is soft deflection of a cloth, or the like, the Non-Patent Document discloses that it is almost possible to correct distortion of a screen, when taking a period of a grid point by fineness of about 16 pixels.

Note that in the present embodiment, here, the intermediate tone level 31 in tones of a background image in the pattern image 30 is taken as a central value of 128 of 256 tones; however, it is only an example, and actually, an input-output characteristic of the projector 1 and the digital camera 22 is not linear, and therefore, it is preferable to be a value in consideration of the above.

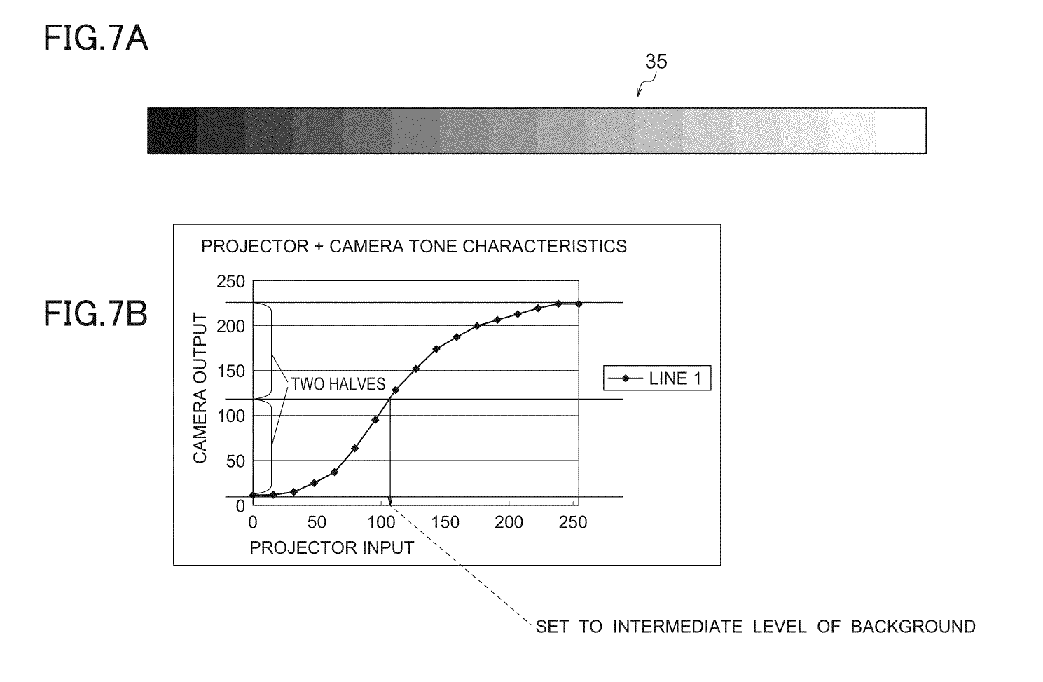

For example, when the projector 1 and the digital camera 22 are combined, and a patch image 35 in which brightness represented in 256 tones is divided equally into 16 scales as illustrated in FIG. 7A is projected, an example of input-output characteristic obtained by imaging and measuring becomes as shown in FIG. 7B. If measuring such a characteristic in advance, it is possible to take the intermediate tone level of the background image as a central value in a range of a camera output of the digital camera 22 illustrated in FIG. 7B. In a case of being thus set, there is no indetermination in either a peak or a bottom of brightness, and therefore, it is easy to perform detection.

Hereinafter, the first detection operation executed by the geometric distortion detection device 19 will be explained.

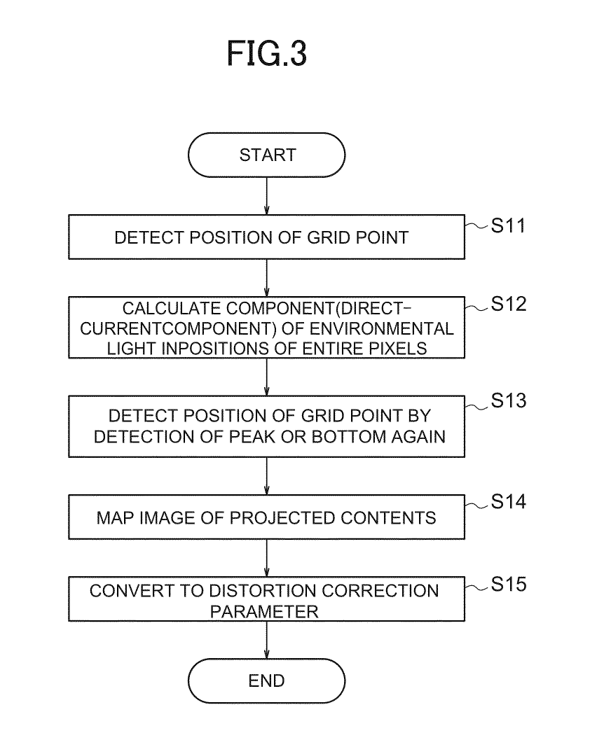

FIG. 3 is a flow diagram illustrating the first detection operation executed by the geometric distortion detection device 19 in the present embodiment. In the projector 1 in the present embodiment, in place of the thin-line grid pattern illustrated in FIG. 8, a projected image of a pattern image illustrated in FIG. 4 projected on the screen 20 is imaged by the digital camera 22, and the imaged image is inputted from the image for distortion correction input part 18.

In this case, the geometric distortion detection part 19, with respect to the imaged pattern image, directly detects a position of a peak or a bottom, and a position of a grid point is detected in a state of including an error due to an influence of environmental light (Step S11). Note that in peak or bottom detection of a peak or a bottom, by using a general Laplacian filter, or the like, the position of the peak, or the bottom can be roughly detected with accuracy of an integer pixel.

Here, the influence of environmental light is assumed to be, for example, a state where a fluorescent light is close to the upper-right of the screen 20, and a vicinity of an upper right edge of the screen 20 is brighter than the rest. In this case, the brightness is also slightly higher in a vicinity of a right upper edge of the projected image of the pattern image. As a result, a peak, or a bottom of brightness becomes slightly flattened, and a waveform of the brightness value is inclined because of addition of the component of environmental light, and therefore, a position of the peak, or the bottom is not obtained with high accuracy.

Next, the geometric distortion detection device 19, from a pixel value in a flat portion as an intermediate position per detected unit of 2×2 grid points, calculates a component (direct current component) of environmental light in positions of entire pixels other than in the above by linear interpolation (Step S12).

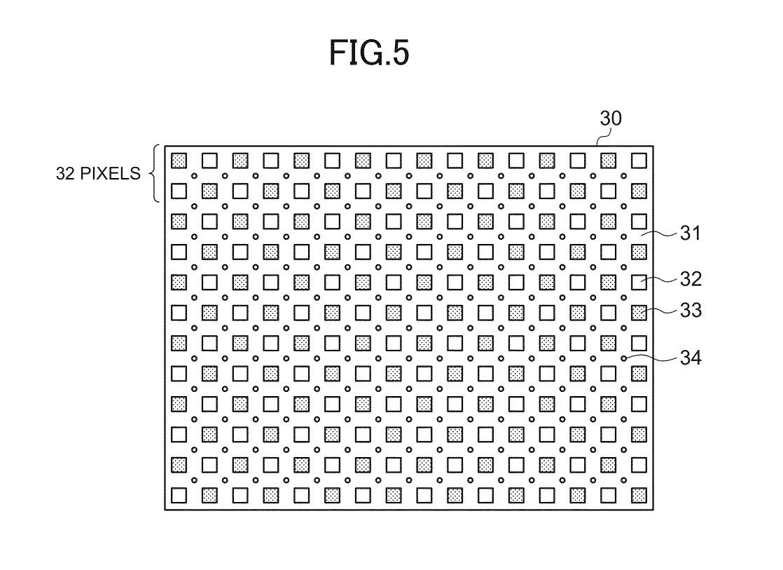

FIG. 5 is a diagram illustrating a position of a pixel in the flat portion as the intermediate position per unit of 2×2 grid points by a white circle 34 when detecting the pattern image 30 illustrated in FIG. 4. Usually, in a projected image, geometric distortion caused by the screen 20 occurs; however, in order to simplify an explanation, a state without distortion is illustrated in FIG. 5.

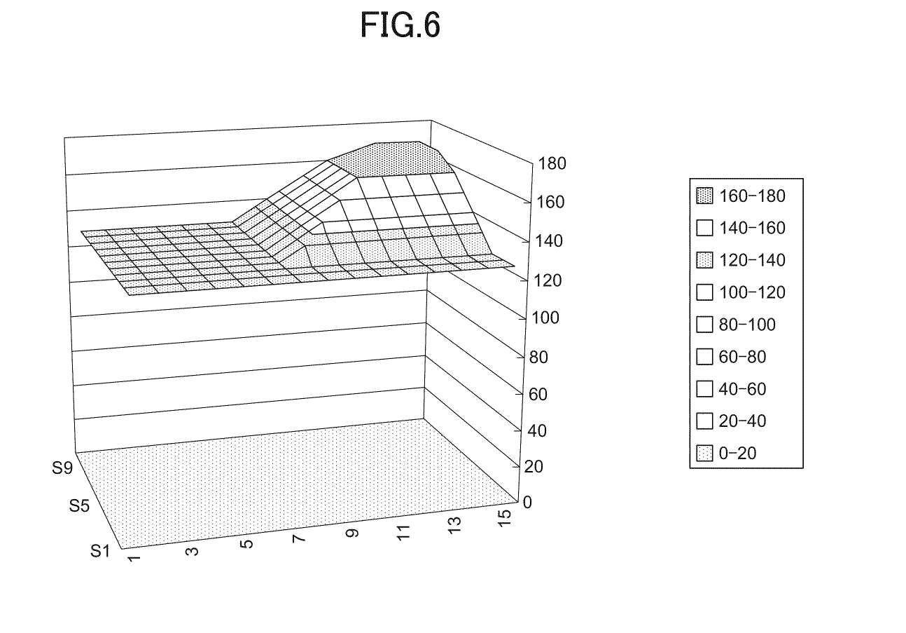

FIG. 6 is a diagram illustrating an example where from the pixel value in the flat portion as the intermediate position per detected unit of 2×2 grid points (brightness value on the imaged image in a position of the white circle 34 in FIG. 5), the component (direct current component) of environmental light in the positions of the entire pixels other than in the above is calculated by the linear interpolation (in a case where the upper right of a picture plane is bright by environmental light).

Note that in an example illustrated in FIG. 6, an entire screen is not covered; however, an outside portion that is not covered is also generated by extrapolating linearly from inside.

Originally, the flat portion is supposed to be ideally at a constant brightness level; however, as illustrated in FIG. 6, the component of environmental light is added, and the brightness level becomes higher toward the upper right.

Next, the geometric distortion detection device 19 subtracts the component of environmental light illustrated in FIG. 6 from the imaged image, and again detects a position of a grid point with accuracy of an integer pixel, by a general Laplacian filter (Step S13).

In the vicinity of a position of an integer pixel of a further obtained peak, or bottom, by obtaining a centroid position weighted by a brightness value, a coordinate of the grid point is obtained with higher accuracy of a number with a decimal point. Now that a state of the distortion of the grid point (coordinate of the grid point on the imaged image) is detected.

Next, the geometric distortion detection device 19 maps an image of contents projected on the screen 20 while maintaining an aspect ratio in a maximum size internally-contacted with a region surrounded by an outer circumference of the obtained grid point (Step S14), and converts a coordinate in each position of the grid point to a coordinate (distortion correction parameter) on a same size original image corresponding to a position on the mapped projected image of the contents (Step S15). That is, the distortion correction parameter that adds transformation opposite to the distortion to the original image is obtained.

Hereinafter, an example of the first detection operation executed by the above geometric distortion detection device 19 will be specifically explained; however, here, in order to simplify the explanation, a case where a thin-line grid pattern illustrated in FIG. 8 is used as a pattern image will be explained.

FIG. 9 is a diagram illustrating an image of contents (aspect ratio 4:3). Here, the size of the image of the contents is the same size as the size of a picture plane of the projector 1, that is, the image of the contents means one frame of a projected image signal.

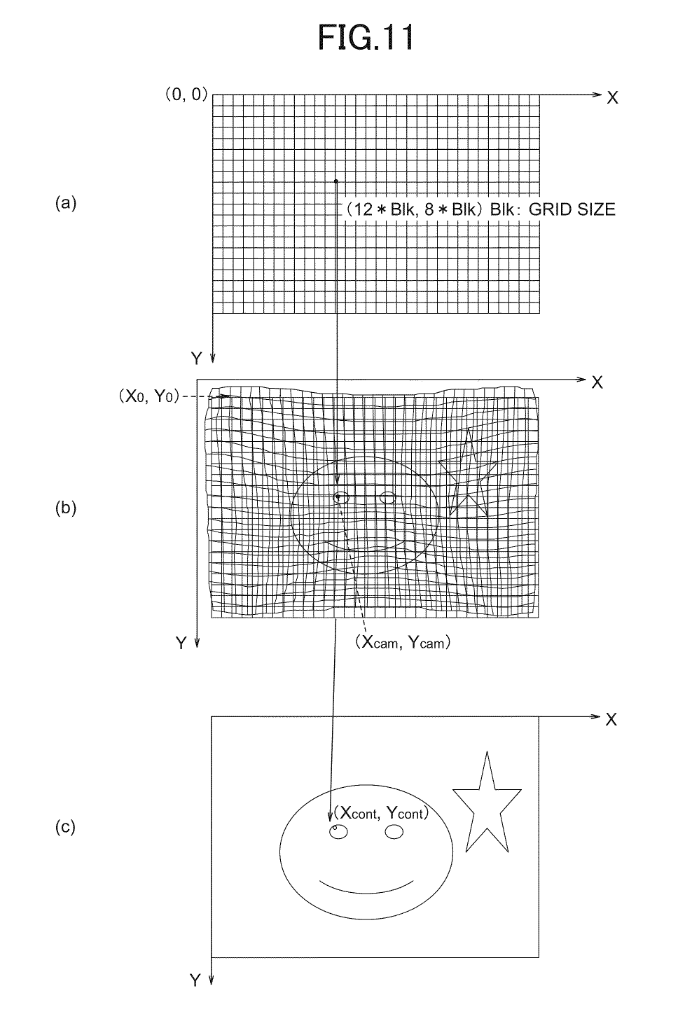

FIG. 10 is a diagram illustrating an example where a projected image of the contents magnified while maintaining an aspect ratio 4:3 in a maximum size internally-contacted with a region surrounded by an outer circumference of the obtained grid point is mapped.

Each of (a), (b), and (c) of FIG. 11 is a diagram illustrating an example where a coordinate in each position of the grid position is converted to a coordinate (distortion correction parameter) on a same size original image corresponding to a position on the mapped projected image of the contents.

A grid pattern on the frame memory 13 of the projector 1 is divided into square blocks, having an origin in the upper left, as illustrated in (a) of FIG. 11. Note that the size of the grid (block) is taken as Blk (pixel).

Each grid point is distorted by distortion of the screen 20, projected as illustrated in (b) of FIG. 11, and imaged by the digital camera 22. All the coordinates of grid points on the projected imaged image are obtained.

Here, for example, in terms of a grid point (a point of a white circle) of a coordinate (12×Blk, 8×Blk) of on an original pattern image illustrated in (a) of FIG. 11, a corresponding position on the imaged image is (Xcam, Ycam).

The image of the contents magnified while maintaining the aspect ratio in the maximum size is mapped in a region to be projected by (b) of FIG. 11.

When a coordinate of the origin on the upper left of the mapped image of the contents is taken as (X0, Y0), and magnification of the image of the contents is taken as R, a pixel position (Xcont, Ycont) of the image of the contents to be projected at this grid point on the imaged image is obtained as follows.

Xcont=(Xcam−X0)/R

Ycont=(Ycam−Y0)/R

Therefore, regarding all grid points, the pixel position (Xcont, Ycont) on the image of the contents is a distortion correction parameter.

Thus, in the projector 1 in the present embodiment, in a case of generating a pattern image in the pattern image generation device 17, a flat portion as an intermediate tone level 31 is set in a background of the pattern image. And in the pattern image, a position of a grid point is specified by a peak portion 32 that is a higher tone level than the intermediate tone level 31 and a bottom portion 33 that is a lower tone level than the intermediate tone level 31.

And in the geometric distortion detection device 19, in a state of including an influence of environmental light, by detecting a peak, or the bottom of the imaged image, the position of the grid point is detected in a state of including an error, from a pixel value in a flat portion as an intermediate position per detected unit of 2×2 grid points, a component (direct-current component) of environmental light in positions of entire pixels other than in the above is calculated by the linear interpolation. And then, with respect to an image where the calculated component of environmental light (direct-current component) is subtracted, by detecting of the peak, or the bottom again, the position of the grid point is detected with higher accuracy, and the distortion correction parameter is obtained.

Next, a geometric distortion correction operation of the geometric distortion correction device 12 in the present embodiment will be explained.

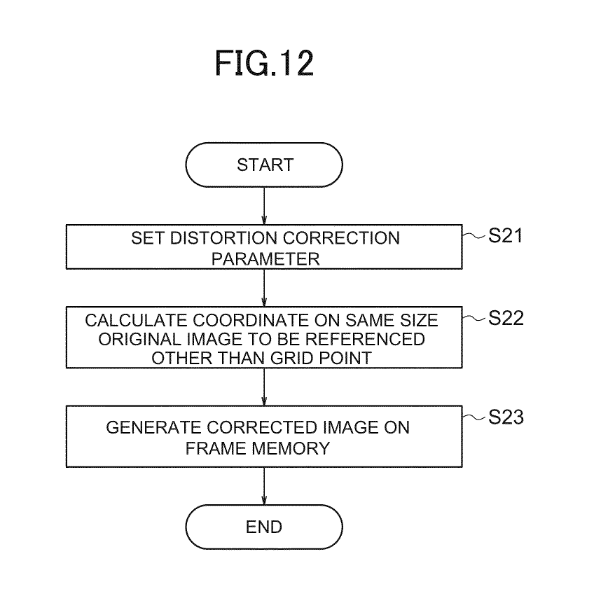

FIG. 12 is a flow diagram illustrating a geometric distortion correction operation executed by the projector 1 in the present embodiment.

The geometric distortion correction device 12, firstly, sets a coordinate (distortion correction parameter) of a position of a grid point on a corrected image projected on the frame memory 13 on a same size original image to be referenced, which is generated by the geometric distortion detection operation of the geometric distortion detection device 19 (Step S21).

Next, a coordinate on the same size original image to be referenced other than the grid point is calculated from the coordinate of the grid point by linear interpolation, and regarding all pixels on the frame memory 13, a coordinate on the same size original image to be referenced is obtained (Step S22). And then, based on a reference coordinate (number with a decimal point), from the original image to be projected, the corrected image is generated on the frame memory 13 by a pixel interpolation method such as a bilinear method, a bicubic method, or the like (Step S23).

In this manner, it is possible to correct the geometric distortion caused by the distortion of the screen 20 with high accuracy in the geometric distortion correction device 12.

Additionally, in the present embodiment, an ultra wide-angle camera with a highly-accurate distance sensor, or an ultra wide-angle stereo camera is not needed in the projector 1, which does not lead to increase in cost.

Furthermore, the number of imagings of a pattern image by the digital camera 22 as an external camera is only once, which has an advantage in that there is no need to perform a plurality of imagings with the external camera fixed, or set a tripod among audience seats.

### SECOND EXAMPLE

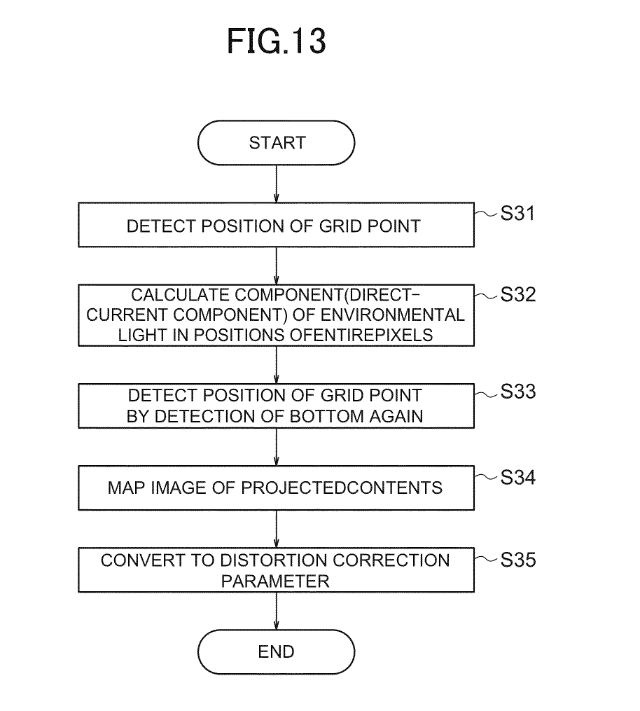

FIG. 13 is a flow diagram illustrating a second detection operation of the geometric distortion detection device 19 of the projector 1 in the present embodiment.

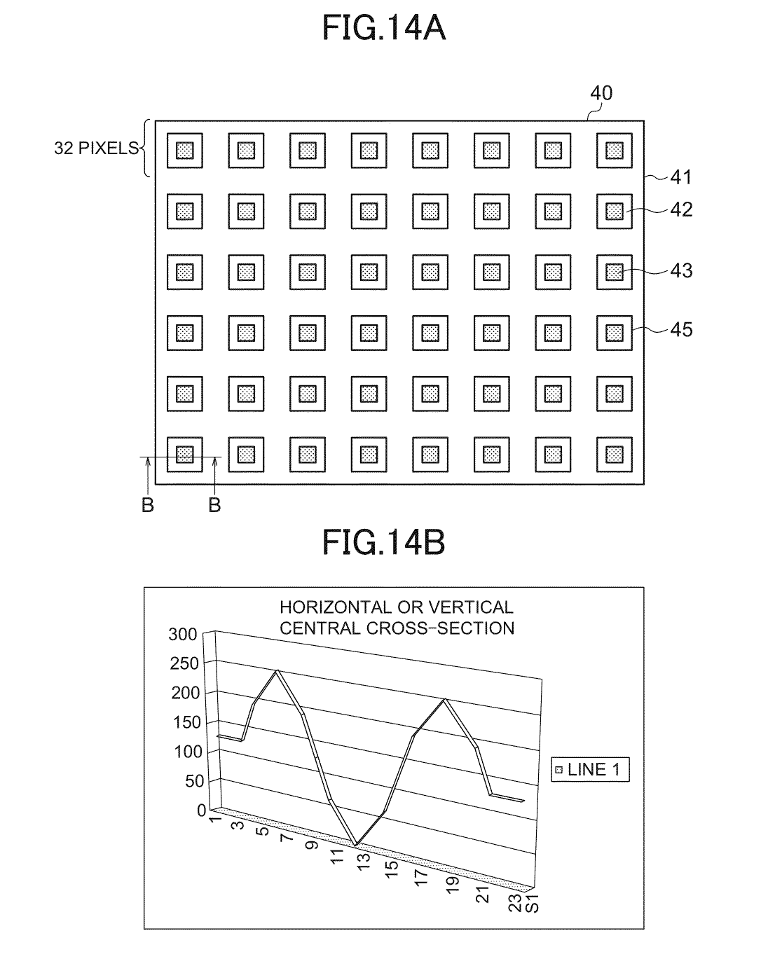

FIG. 14A is a pattern image in the second detection operation. FIG. 14B is a cross-sectional diagram in a line B-B of a brightness value of the pattern image illustrated in FIG. 14A.

Note that in FIGS. 14A and 14B, in order to simplify an explanation, an image of a 256×192 pixel size is illustrated. A difference between the first detection operation and the second detection operation is that a different pattern image for geometric detection correction is used, respectively, and therefore, a part of the geometric distortion detection operation is different.

In a pattern image 40 illustrated in FIG. 14A, a background of an intermediate tone level (a brightness value of 128 in this example) 41 is included, and additionally, an image pattern 45 is arranged as a position of a grid point (unit of 32 pixels) including a peak portion 42, and a bottom portion 43 surrounded by the peak portion 42. The peak portion 42 is a high tone portion in which the brightness value is higher than in the intermediate tone level 41, and the bottom portion 43 is a low tone portion in which the brightness value is lower than in the intermediate tone level 41.

A difference between the pattern image illustrated in FIG. 4A and the pattern image illustrated in FIG. 14A is that it is possible to increase a contrast ratio in the low tone portion (bottom portion 43) in the image pattern 45 illustrated in FIG. 14A, and there is an advantage in that robustness of detection increases.

In this case, the geometric distortion detection device 19, firstly, detects a position of a grid point in a state of including an error due to an influence of environmental light by bottom detection in the imaged pattern image 40 (Step S31).

Next, the geometric distortion detection device 19, from a pixel value in a flat portion as an intermediate position per detected unit of 2×2 grid points, calculates a component (direct-current component) of environmental light in positions of entire pixels other than in the above by linear interpolation (Step S32).

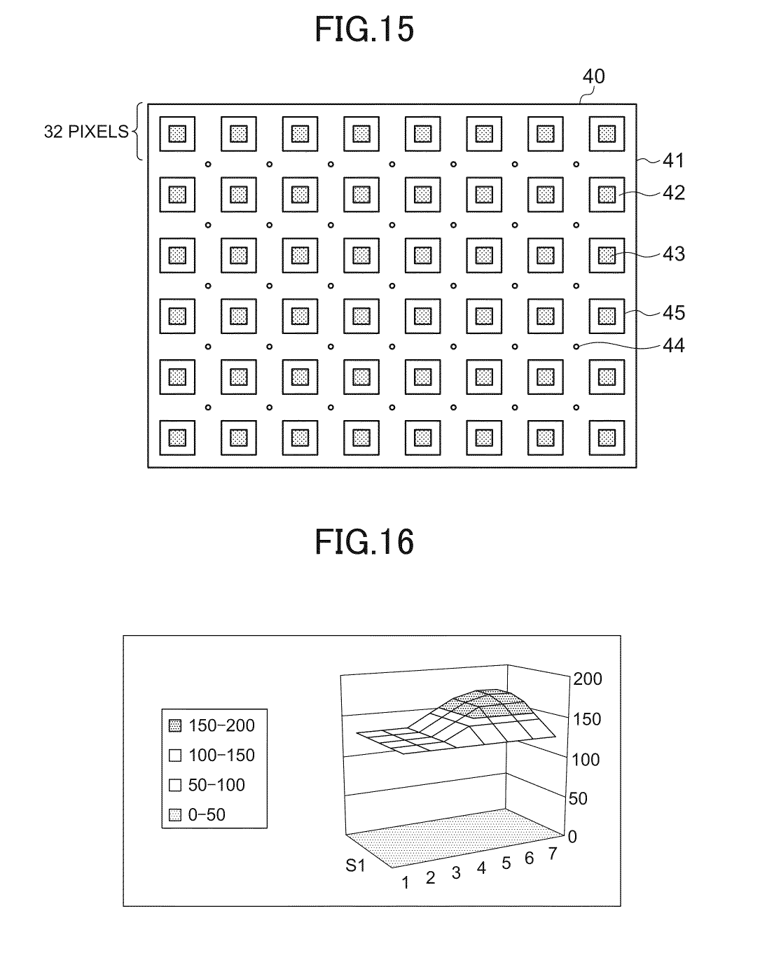

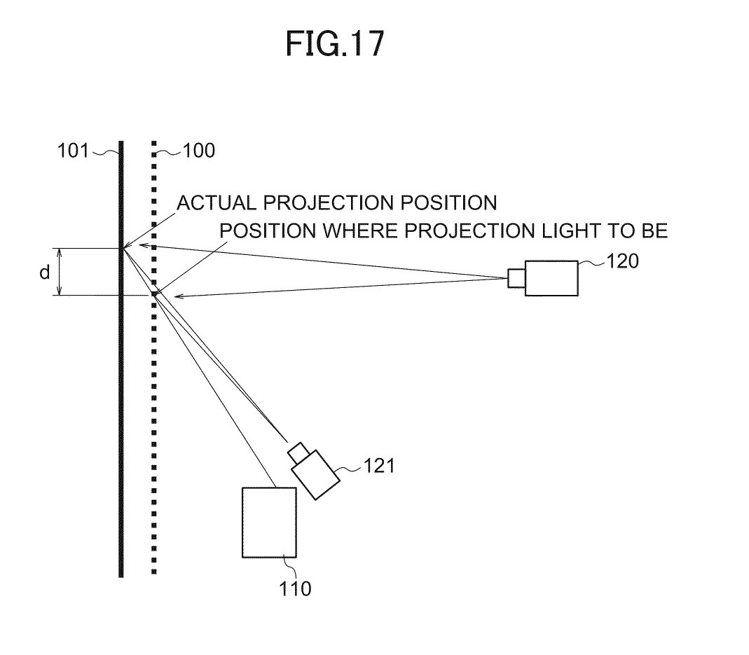

In FIG. 15, a position of a pixel in the flat portion as the intermediate position per unit of 2×2 grid points when detecting the pattern image illustrated in FIG. 14A is illustrated by a white circle 44. Usually, in a projected image, geometric distortion caused by the screen 20 occurs; however, in order to simplify an explanation, a state without the geometric distortion is illustrated in FIG. 15.

FIG. 16 is a diagram illustrating an example (a case where the upper right of a picture plane is brighter by environmental light) where from a brightness value in the flat portion as the intermediate position per detected unit of 2×2 grid points (a brightness value on the imaged image in a position of the white circle 44 in FIG. 15), a component (direct-current component) of environmental light in the positions of the entire pixels other than in the above is calculated by linear interpolation. Note that in the example illustrated in FIG. 16, an entire screen 20 is not covered; however, an outside portion that is not covered is also generated by extrapolation linearly from inside.

Originally, a brightness level in the flat portion is supposed to be constant ideally; however, as illustrated in FIG. 16, the brightness level becomes higher toward the upper right because of addition of the component of environmental light.

Next, the geometric distortion detection device 19 subtracts the component of environmental light illustrated in FIG. 16 from the imaged image, and again detects a position of the grid point with accuracy of an integer pixel, by a general Laplacian filter, or the like (Step S33).

Next, the geometric distortion detection part 19 maps an image of contents projected on the screen 20 while maintaining an aspect ratio in a maximum size internally-contacted with a region surrounded by an outer circumference of the detected grid point (Step S34), and converts a coordinate in each position of the grid point to a coordinate (distortion correction parameter) on a same size original image corresponding to a position on the mapped projected image of the contents (Step S35).

In this manner, in Second Example, in a case of generating the pattern image 40 in the pattern image generation device 17, the flat portion as the intermediate tone level 41 is set in a background of a pattern image. In the pattern image 40, the position of the grid point is specified by the peak portion 42 which is higher than the intermediate tone level 41, and the bottom portion 43 which is lower than the intermediate tone level 41 and surrounded by the peak portion 42. And in the geometric distortion detection device 19, in the state of including the influence of environmental light, by detecting the peak portion 42, or the bottom portion 43 in the imaged image, the position of the grid point is detected in the state of including the error. And from the pixel value in the flat portion 41 as the intermediate position per each detected unit of 2×2 grid points, the component (direct-current point) of environmental light in the positions of the entire pixels other than in the above is calculated by linear interpolation. In the image where the calculated component of environmental light is subtracted, by detecting the bottom portion again, the position of the grid point is detected with high accuracy, and the distortion correction parameter is obtained. Also in a case of the above constitution, an effect similar to that of First Example is obtained.

Note that the above projector is an embodiment of the present invention, and the projector according to the embodiment of the present invention can be an arbitrary combination of the above constituents. And a method, a system, a computer program, a storage medium, and the like according to the embodiment of the present invention have the same constitution.

The program can be stored in a storage medium. By using this storage medium, it is possible to install the program on a computer. Here, the storage medium storing the program can be a non-transitory storage medium. The non-transitory storage medium is not particularly limited, and it can be a storage medium such as a CD-ROM, or the like.

In particular, a method of image projection includes the steps of: generating image data of a pattern image that specifies a position of a grid point by a flat portion as an intermediate tone level of a background image, a high tone portion that is a higher tone level than the intermediate tone level and a low tone portion that is a lower tone level than the intermediate tone level; projecting the pattern image on a screen; inputting an imaged image for correction; detecting geometric distortion information of the grid point which divides the imaged image for correction into blocks, based on an imaged image for correction in which the pattern image projected on the screen has been imaged and inputted in the step of inputting the imaged image for correction; and correcting geometric distortion of a projected image projected on the screen based on the geometric distortion information.

The step of detecting the geometric distortion, by using a pixel value of the flat portion of the imaged image for correction inputted in the step of inputting the imaged image for correction, corrects a component of environmental light of an imaged image for correction in which the pattern image projected on the screen has been imaged, and based on the above corrected imaged image, detects geometric distortion information of a grid point which divides a projected image projected on the screen.

The intermediate tone level of the pattern image is determined by a previously-measured input-output characteristic of an image projector and an imaging device that images the pattern image on the screen.

A non-transitory computer-readable storage medium storing a program for causing a computer to execute image projection includes the steps of: generating image data of a pattern image which specifies a position of a grid point by a flat portion as an intermediate tone level of a background image, a high tone portion that is a higher tone level than the intermediate tone level and a low tone portion that is a lower tone level than the intermediate tone level; projecting the pattern image on a screen; inputting an imaged image for correction; detecting geometric distortion information of the grid point which divides the imaged image for correction into blocks based on an imaged image for correction in which the pattern image projected on the screen has been imaged and inputted in the step of inputting the imaged image for correction; and correcting geometric distortion of a projected image projected on the screen based on the geometric distortion information.

An image projector uses the non-transitory computer-readable storage medium storing the computer program for causing the computer to execute the image projection.

According to the embodiment of the present invention, it is easily possible to correct geometric distortion caused by distortion of a screen without an increase in cost.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An image projector, comprising:
a pattern image generation device that generates image data of a pattern image which specifies a position of a grid point by a flat portion as an intermediate tone level of a background image, a high tone portion which is a higher tone level than the intermediate tone level and a low tone portion which is a lower tone level than the intermediate tone level;
a projection device that projects the pattern image on a screen;
an image for correction input device that inputs an imaged image for correction;
a geometric distortion detection device that detects geometric distortion information of the grid point which divides the imaged image for correction into blocks based on an imaged image for correction in which the pattern image projected on the screen has been imaged and inputted by the image for correction input device; and
a geometric distortion correction device that corrects geometric distortion of a projected image projected on the screen by the projection device based on the geometric distortion information.

2. An image projector, comprising:
a pattern image generation device that generates image data of a pattern image which specifies a position of a grid point by a flat portion as an intermediate tone level of a background image, a high tone portion that is a higher tone level than the intermediate tone level, and a low tone portion that is a lower tone level than the intermediate tone level and surrounded by the high tone portion;
a projection device that projects the pattern image on a screen;
an image for correction input device that inputs an imaged image for correction;
a geometric distortion detection device that detects geometric distortion information of the grid point which divides the imaged image for correction into blocks based on an imaged image for correction in which the pattern image projected on the screen has been imaged and inputted by the image for correction input device; and
a geometric distortion correction device that corrects geometric distortion of a projected image projected on the screen by the projection device based on the geometric distortion information.

3. The image projector according to claim 1, wherein the geometric distortion detection device, by using a pixel value of the flat portion of the imaged image for correction inputted by the image for correction input device, corrects a component of environmental light of an imaged image for correction in which the pattern image projected on the screen has been imaged, and based on the above corrected imaged image, detects geometric distortion information of a grid point which divides a projected image projected on the screen by the projection device.

4. The image projector according to claim 1, wherein the intermediate tone level of the pattern image is determined by a previously-measured input-output characteristic of the image projector and an imaging device that images the pattern image on the screen.

5. A method of image projection, comprising the steps of:
generating image data of a pattern image that specifies a position of a grid point by a flat portion as an intermediate tone level of a background image, a high tone portion that is a higher tone level than the intermediate tone level and a low tone portion that is a lower tone level than the intermediate tone level;
projecting the pattern image on a screen;
inputting an imaged image for correction;
detecting geometric distortion information of the grid point which divides the imaged image for correction into blocks, based on an imaged image for correction in which the pattern image projected on the screen has been imaged and inputted in the step of inputting the imaged image for correction; and
correcting geometric distortion of a projected image projected on the screen based on the geometric distortion information.

6. The method of image projection according to claim 5, wherein the step of detecting the geometric distortion, by using a pixel value of the flat portion of the imaged image for correction inputted in the step of inputting the imaged image for correction, corrects a component of environmental light of an imaged image for correction in which the pattern image projected on the screen has been imaged, and based on the above corrected imaged image, detects geometric distortion information of a grid point which divides a projected image projected on the screen.

7. The method of image projection according to claim 5, wherein the intermediate tone level of the pattern image is determined by a previously-measured input-output characteristic of an image projector and an imaging device that images the pattern image on the screen.

8. A non-transitory computer-readable storage medium storing a program for causing a computer to execute image projection, comprising the steps of:
generating image data of a pattern image which specifies a position of a grid point by a flat portion as an intermediate tone level of a background image, a high tone portion that is a higher tone level than the intermediate tone level and a low tone portion that is a lower tone level than the intermediate tone level;
projecting the pattern image on a screen;
inputting an imaged image for correction;
detecting geometric distortion information of the grid point which divides the imaged image for correction into blocks based on an imaged image for correction in which the pattern image projected on the screen has been imaged and inputted in the step of inputting the imaged image for correction; and
correcting geometric distortion of a projected image projected on the screen based on the geometric distortion information.

9. An image projector using the non-transitory computer-readable storage medium storing the program for causing the computer to execute the image projection according to claim 8.
